(19) United States
(12) Patent Application Publication
(10) Pub. No.: US 2025/0079759 A1
(43) Pub. Date: Mar. 6, 2025

(54) CONTACT GUIDING DEVICE

(71) Applicant: GENERAL PLASTIC INDUSTRIAL CO., LTD., Taichung City (TW)

(72) Inventor: Kuan-Tung LI, Taichung City (TW)

(73) Assignee: GENERAL PLASTIC INDUSTRIAL CO., LTD., Taichung City (TW)

(21) Appl. No.: 18/242,772

(22) Filed: Sep. 6, 2023

(51) Int. Cl. H01R 13/629

(52) U.S. Cl. CPC H01R 13/629

(57) ABSTRACT

A contact guiding device, which is adapted for being contacted with at least one electric contact, includes a mounting frame, a chip module, and a guiding structure. The chip module includes a substrate connected with the mounting frame, and at least one terminal mounted to the substrate. The guiding structure is provided at the mounting frame or the terminal for guiding the electric contact into contact with the terminal when the terminal approaches the electric contact. As a result, the contact guiding device can guide the electric contact to a correct position to ensure proper contact with the terminal, thereby preventing the electric contact from deformation and correcting the already deformed electric contact.

### BACKGROUND OF THE INVENTION

### 1. Field of the Invention

The present invention relates generally to an electronic apparatus and more particularly, to a contact guiding device for an electronic apparatus.

### 2. Description of the Related Art

Electronic apparatuses are widely used in modern life. In order to transmit signals or control actions between different units of electronic apparatuses, terminals and electric contacts must be electrically contacted with each other so as to achieve the purpose of communicating information or controlling operations. Taking electronic image-forming apparatus, such as printers, as an example, replaceable cartridges, such as toner cartridges, ink cartridges, and photosensitive drums, must be installed in the printer to provide toner supply, ink supply, or other predetermined functions. In order to communicate information or control operations, these cartridges are equipped with multiple terminals. When the cartridges are installed in the printer, the terminals on the cartridges can be contacted with multiple electric contacts of the printer, thereby facilitating communication of information or transmission of control signals.

Due to unavoidable dimensional tolerances during manufacturing, to ensure positive and stable contact of the electric contacts of the printer with the terminals of the cartridges, the electric contacts are typically made in the form of flexible and deformable spring strip. However, because these electric contacts are flexible, when users install the cartridges, an incorrect alignment may lead to the distortion of the spring strip, or in a worse situation may cause poor contact between the terminals and the electric contacts. This conventional design provides no guiding or aligning mechanism. Once these spring strips become askew distorted, the problem of poor contact will get worse and worse, causing incorrect connections or even disconnections eventually. Therefore, the conventional design needs to be improved.

### SUMMARY OF THE INVENTION

The present invention has been accomplished in view of the above-noted circumstances. It is an objective of the present invention to provide a contact guiding device, which can guide the electric contact to a correct position to ensure a proper connection with the terminal.

It is another objective of the present invention to provide a contact guiding device, which can prevent the electric contact from deformation and can guide and align a deformed electric contact with the terminal or even correct the deformed electric contact.

To attain the above-mentioned objectives, the present invention provides a contact guiding device adapted for being contacted with at least one electric contact and comprising a mounting frame, a chip module, and a guiding structure. The chip module includes a substrate connected with the mounting frame, and at least one terminal mounted to the substrate. The guiding structure is provided at the mounting frame or the terminal for guiding the electric contact into contact with the terminal when the terminal approaches the electric contact. As a result, the contact guiding device can guide the electric contact to a correct position to ensure proper contact with the terminal, thereby preventing the electric contact from deformation, guiding and aligning the already deformed electric contact with the terminal, and correcting the already deformed electric contact.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view, showing that a contact guiding device according to a first embodiment of the present invention is coupled to electric contacts;

FIG. 2 is an exploded perspective view, showing the contact guiding device of the first embodiment of the present invention and the electric contacts;

FIG. 3 is a partially cutaway exploded perspective view, showing the contact guiding device of the first embodiment of the present invention and the electric contacts;

FIG. 4 is a perspective view of the contact guiding device of the first embodiment of the present invention;

FIG. 5 is a partially cutaway perspective view of the contact guiding device of the first embodiment of the present invention;

FIG. 6 is a partially cutaway perspective view of a contact guiding device according to a second embodiment of the present invention; and

FIG. 7 is a partially cutaway perspective view of a contact guiding device according to a third embodiment of the present invention.

### DETAILED DESCRIPTION OF THE INVENTION

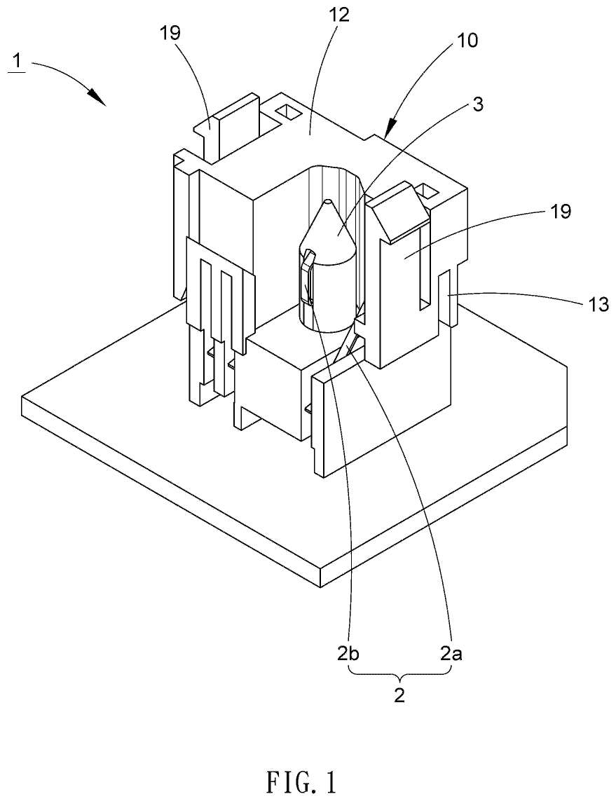

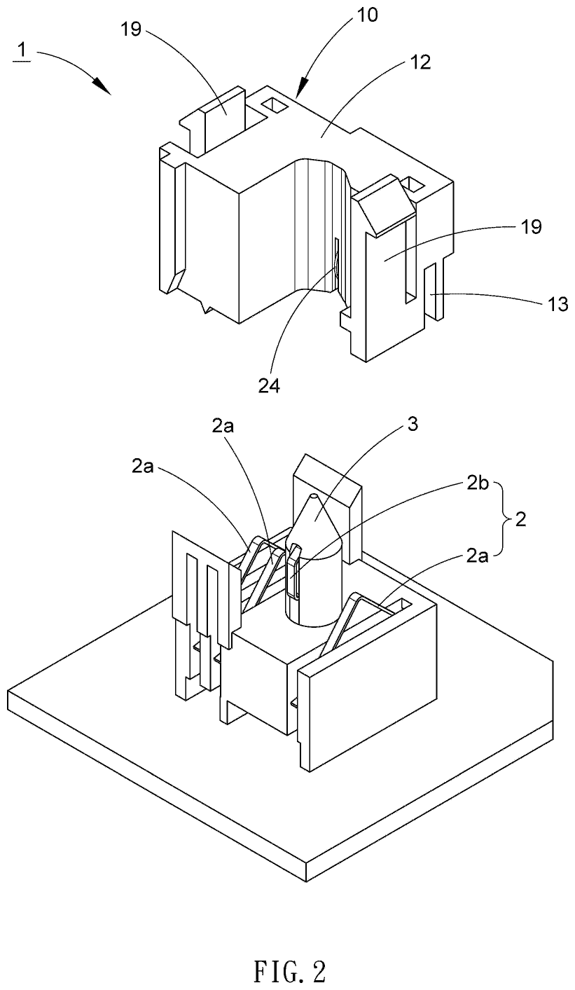

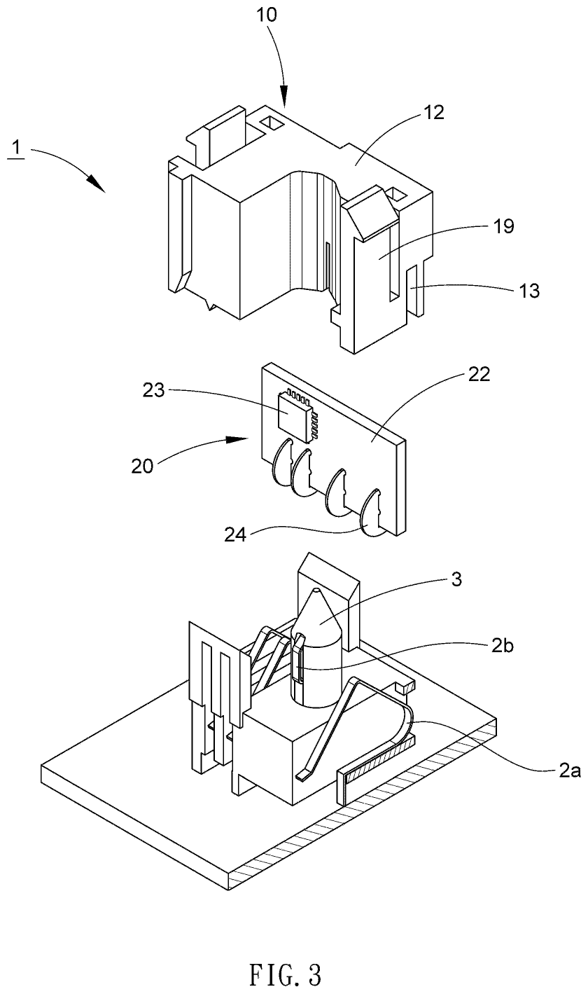

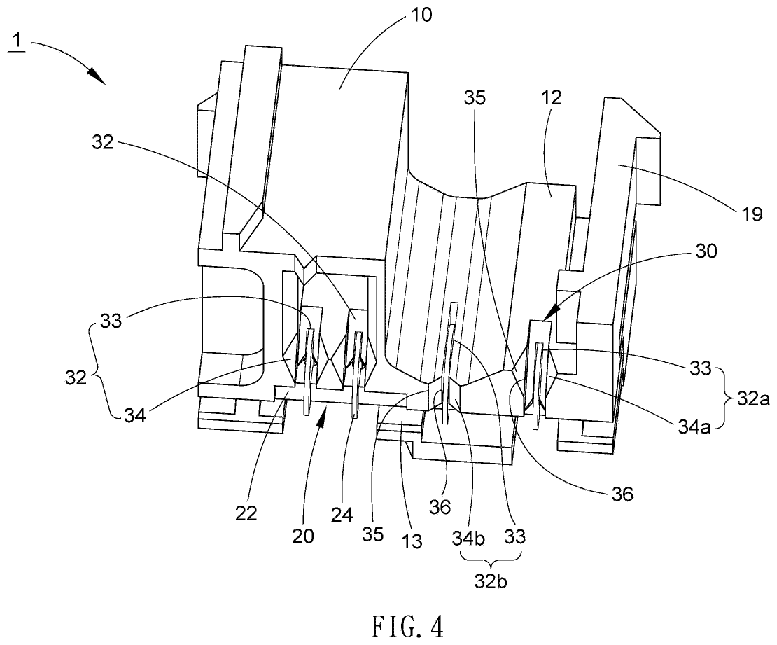

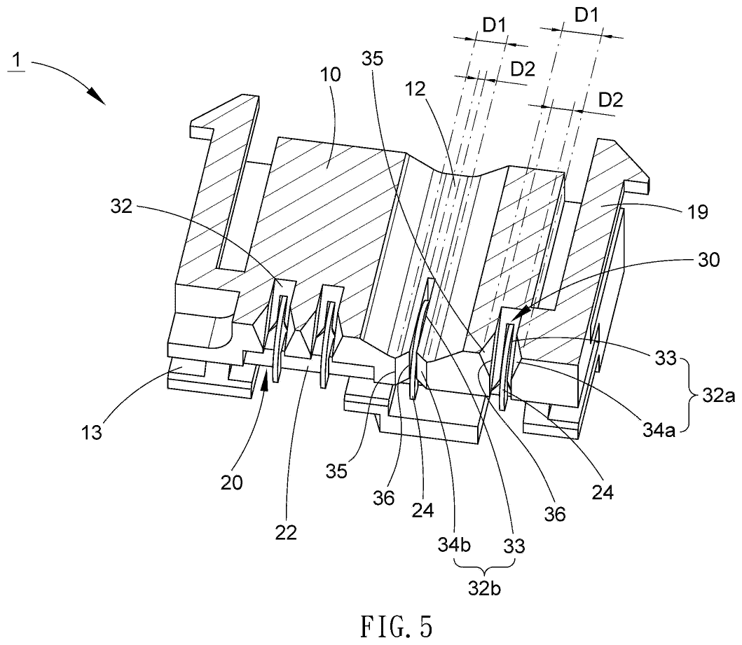

Hereunder three embodiments will be detailedly described with accompanying drawings for illustrating technical features and structure of the present invention. FIGS. 1-5 depict a contact guiding device 1 in accordance with a first preferred embodiment of the present invention. The contact guiding device 1 is adapted for being installed in a first electronic apparatus (not shown), such as toner cartridge, and for being coupled with a second electronic apparatus (not shown), such as printer. The printer is provided with four electric contacts 2, including three communication conductive strips 2a, and one grounding conductive strip 2b. The contact guiding device 1 is used to contact the four electric contacts 2. The contact guiding device 1 is composed of a mounting frame 10, a chip module 20, and a guiding structure 30.

The mounting frame 10 includes a main body 12, a receiving groove 13 recessed inwardly from a bottom side of the main body 12, and two resilient arms 19 extending outward from two opposite sides of the main body 12. The two resilient arms 19 are used to engage with the toner cartridge, thereby connecting the mounting frame 10 to the toner cartridge.

The chip module 20 is composed of a substrate 22 connected to the mounting frame 10, a processing chip 23 disposed on the substrate 22, and four terminals 24 disposed to the substrate 22 and electrically connected with the processing chip 23. The substrate 22 is accommodated in the receiving groove 13 of the mounting frame 10, and the four terminals 24 are basically sheet pieces having a semi-circular shape. However, the shape or structure of the terminals 24 can be changed as needed.

The guiding structure 30 is provided at the mounting frame 10 and configured in a way that when the terminals 24 approach the electric contacts 2, the guiding structure 30 guides the electric contacts 2 to correct positions to make them contact the terminals 24 positively and stably. The guiding structure 30 includes four guide grooves 32 provided at the main body 12 of the mounting frame 10. Each guide groove 32 has a groove body 33 and an opening 34. The groove bodies 33 allow that the terminals 24 extend into the groove bodies 33, respectively. The four groove bodies 33 are parallel to each other and communicate with the receiving groove 13. The opening 34 has a wide end 35 and a narrow end 36. The wide end 35 faces the respective electric contact 2, and the narrow end 36 is connected to the groove body 33. The width D1 of the wide end 35 is greater than the width D2 of the narrow end 36. The width of the opening 34 is gradually reduced from the wide end 35 to the narrow end 36 in a continuous manner. However, in another embodiment, the width of the opening 34 can also decrease in a stepwise or irregular manner.

In this embodiment, the structures of the four electric contacts 2 are different. Specifically, the three communication conductive strips 2a are realized as bent spring strips having an exposed portion shaped like a part of triangle. While the grounding conductive strip 2b has two exposed portions of upright shape and the two exposed portions of the grounding conductive strip 2b are positioned on two opposite lateral sides of a post 3. It is to be noted that in FIGS. 1-3, only one exposed portion of the grounding conductive strip 2b is shown. To associate with the four electric contacts 2, the openings 34 have different structures accordingly. Specifically, the three guide grooves 32a corresponding to the three communication conductive strips 2a have their openings 34a facing laterally downward, aligning precisely with the predetermined contact positions (slope portions) of the three communication conductive strips 2a, respectively. The guide groove 32b corresponding to the grounding conductive strip 2b has its opening 34b facing directly downward. When the terminals 24 move downward and approach the electric contacts 2, the sidewalls of these openings 34 guide the electric contacts 2 into proper alignment with the terminals 24. This ensures that when the mounting frame 10 is coupled with the printer, these electric contacts 2 can be positively and stably contacted with the terminals 24 to constitute electrical connections therebetween.

Furthermore, since these openings 34 are all funnel-shaped having a wider outer end and a narrower inner end, they not only prevent the electric contacts 2 from deformation but also prevent further deformation of the already deformed electric contacts 2, and they can even guide and align the already deformed electric contacts 2 with the terminals 24 or correct or reshape the already deformed electric contacts 2 into a non-deformation manner, thereby achieving the objectives of the present invention.

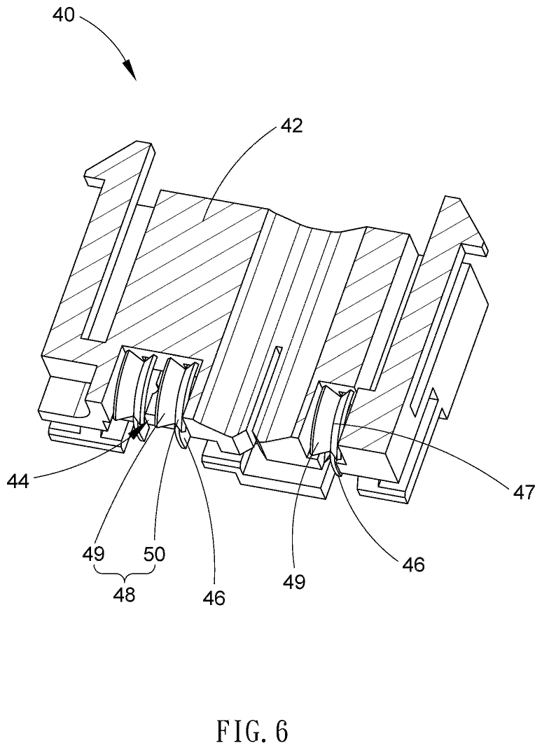

Based on the above-mentioned technical features, various modifications to the structure of the contact guiding device 1 may be made. For example, FIG. 6 illustrates a contact guiding device 40 according to a second preferred embodiment of the present invention. Similar to the contact guiding device 1 of the first embodiment, the contact guiding device 40 also includes a mounting frame 42, a chip module 44, and terminals 46 each being realized as a sheet piece having an end edge 47 of arched shape. The difference between the contact guiding device 40 and the contact guiding device 1 of the first embodiment lies in that the guiding structure 48 is provided at the terminals 46. Specifically, the guiding structure 48 comprises a left branch 49 extending leftward from the end edge 47 of the terminal 46, and a right branch 50 extending rightward from the end edge 47. The left branch 49 and the right branch 50 may be made of the same material as the terminal 46. The left and right branches 49 and 50 are configured in a way that the farther away from the end edge 47, the greater the distance between the left branch 49 and the right branch 50. That is, the distance between the left branch 49 and the right branch 50 increases in a direction away from the end edge 47 of the terminal 46. With this configuration, the contact guiding device 40 not only guides the electric contacts to make secure contact with the terminals 46 but also prevents the electric contacts from deformation and can correct or reshape the already deformed electric contacts, providing an effective solution to achieve the objectives of the present invention.

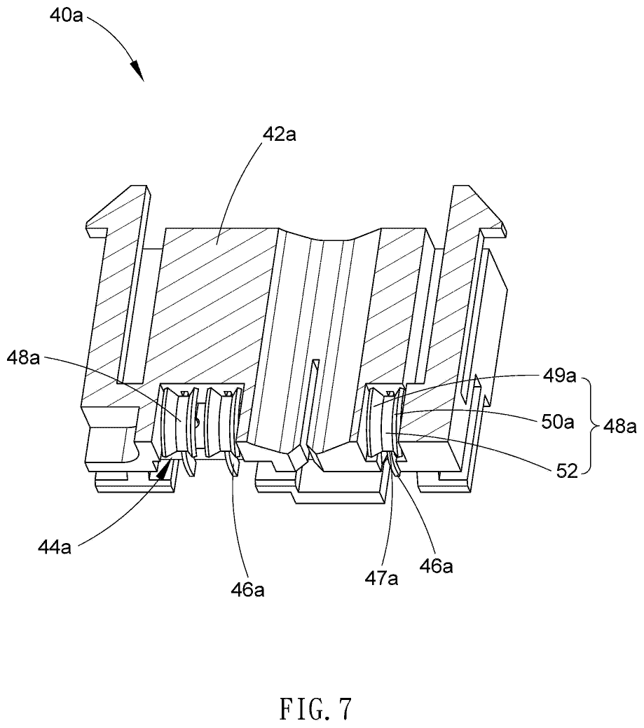

Moreover, FIG. 7 illustrates a contact guiding device 40a according to a third preferred embodiment of the present invention. It shares similarities with the previous embodiments, including the mounting frame 42a, chip module 44a, and terminals 46a. In this embodiment, the terminals 46a are realized as sheet pieces each having an end edge 47a of arched shape. The guiding structure 48a of this embodiment differs from that of the second embodiment in that the end edge 47a of the terminal 46a further comprises a plate portion 52. The left branch 49a extends leftward from the plate portion 52, and the right branch 50a extends rightward from the plate portion 52. The plate portion 52 provides a larger contact area for being in contact with the electric contact, such that the contact guiding device 40a can guide the electric contacts to contact with the terminals 46a more positively and stably.

In view of the above, the guiding structure may be modified as long as it is configured having a wider outer part and a narrower inner part, which can guide the electric contacts to the correct positions in contact with the terminals. Such variations are not to be regarded as a departure from the spirit and scope of the invention, and all such modifications as would be obvious to one skilled in the art are intended to be included within the scope of the following claims.

What is claimed is:

1. A contact guiding device for being contacted with at least one electric contact, the contact guiding device comprising:
a mounting frame;
a chip module comprising a substrate connected with the mounting frame, and at least one terminal mounted to the substrate; and
a guiding structure provided at the mounting frame or the terminal for guiding the electric contact into contact with the terminal when the terminal approaches the electric contact.

2. The contact guiding device as claimed in claim 1, wherein the guiding structure comprises at least one guide groove provided at the mounting frame; the guide groove includes a groove body, into which the terminal extends, and an opening having a wide end facing the electric contact, and a narrow end connected with the groove body.

3. The contact guiding device as claimed in claim 2, wherein the opening of the guide groove has a width gradually reduced from the wide end to the narrow end in a continuous or stepwise manner.

4. The contact guiding device as claimed in claim 1, wherein the guiding structure comprises a left branch extending leftward from an end edge of the terminal, and a right branch extending rightward from the end edge of the terminal in a way that a distance between the left branch and the right branch increases in a direction away from the end edge of the terminal.

5. The contact guiding device as claimed in claim 4, wherein the distance between the left branch and the right branch gradually increases in the direction away from the end edge of the terminal in a continuous or stepwise manner.

6. The contact guiding device as claimed in claim 4, wherein the terminal is a sheet piece having the end edge of arched shape.

7. The contact guiding device as claimed in claim 6, wherein the end edge of the terminal comprises a plate portion; the left branch extends leftward from the plate portion, and the right branch extends rightward from the plate portion.

8. The contact guiding device as claimed in claim 4, wherein the end edge of the terminal comprises a plate portion; the left branch extends leftward from the plate portion, and the right branch extends rightward from the plate portion.

9. The contact guiding device as claimed in claim 1, wherein the mounting frame comprises a receiving groove accommodating the substrate of the chip module.

10. The contact guiding device as claimed in claim 1, wherein the contact guiding device is provided at a toner cartridge, and the electric contact is provided at an electronic image-forming apparatus.
